(19) United States
(12) Patent Application Publication
(10) Pub. No.: US 2015/0248501 A1
(43) Pub. Date: Sep. 3, 2015

(54) CONTENT ANALYTICS

(71) Applicant: ELATERAL, INC., Westchester, IL (US)

(72) Inventors: Alexandre Perry Kamel, Castle Pines, CO (US); Peter Blackburn, Farnham (GB); Paul Goater, Farnham (GB)

(21) Appl. No.: 14/433,165

(22) PCT Filed: Oct. 2, 2013
(86) PCT No.: PCT/US13/62971

§ 371 Date: Apr. 2, 2015

Related U.S. Application Data
(60) Provisional application No. 61/744,734, filed on Oct. 3, 2012.

(51) Int. Cl. G06F 17/30

(52) U.S. Cl. CPC G06F 17/30997; G06F 17/30864; G06F 17/30528

(57) ABSTRACT

A content analytics system and method are described. The content analytics system can include a server, an asset database, a network, an end user device, and a behavioral analytics data repository. The content analytics process can include, but is not limited to, attaching dynamic, event-based, behavioral analytics data associated with communications initiatives to an asset.

### CROSS-REFERENCE TO RELATED APPLICATION

This application claims the benefit of U.S. Provisional Application No. 61/744,734, filed Oct. 3, 2012.

### BACKGROUND

Data collection and analysis are widely used today for purposes of characterizing, understanding, and improving communications between individuals and/or organizations in order to achieve desired outcomes. This is prevalent in the fields of marketing, advertising, sales, and customer service. Methods to date have focused on the collection and analysis of data related to events associated with such communications.

One method for analyzing communications initiatives is known as behavioral analytics. Behavioral analytics can be defined by data and related analytics associated with delivery of communications across one or more medium, receipt of the communications, and a variety of possible responses or actions by or between the sender and receiver. Behavioral analytics is also referred to as event-based analytics, conversion analytics, outcome analytics, and campaign analytics.

Behavioral analytics are useful for purposes of evaluating an effectiveness of a communications initiative in achieving one or more desired outcomes. By capturing and analyzing behavioral analytics and related contextual analytics, a person can assess the effectiveness of a communication and ascertain factors which contributed positively or negatively to the effectiveness of the communications initiative. Contextual analytics can be referred to as analyzing contextual factors within which the communication and related behaviors take place. Contextual factors generally include, but are not limited to, market segments, geographies, product categories, media channels, etc.

Communications generally include one or more assets that make up the communication. Assets can include, but are not limited to, photographic images, artwork, headlines, body copy, call to action, colors, dimensions, layouts, templates, etc. A typical communication generally involves (i) an assembly of one or more assets and (ii) a delivery of the assets via one or more media or medium. Generic asset data and related analytical insights are typically associated with a communications initiative.

Conventional behavioral analytic practices aim to associate behavioral analytics for a given communications initiative with contextual factors that contribute to an effectiveness of the communications initiative. Through conventional methods, practitioners are able to identify that certain combinations of assets and their attributes contribute favorably or unfavorably to an effectiveness of a communication under various conditions.

The conventional approach creates an initiative-centric view of an effectiveness of a communication along with an initiative-centric appreciation for a contribution of an asset to the initiative. Generally, behavioral analytics are associated with a particular initiative. Data can be analyzed to ascertain an effectiveness of the initiative with regard to achievement of desired outcomes. In this context, the relative contribution of assets to an initiative can be examined along with other contextual factors.

While conventional behavioral analytics are useful in understanding and managing the dynamic aspects of communications and related outcomes, behavioral analytics are limited in their ability to associate insights with and attach persistent attributes to assets which characterize an effectiveness of a communication. Behavioral analytics have a limited ability to (i) associate and characterize cumulative contributions of an asset, individually or in various combinations, to an effectiveness of one or more communications initiatives, and (ii) determine a capacity of an asset to contribute disproportionately to performance across a range of initiatives and related contexts over time. The ability to derive practical insights regarding assets, their source of origination, and their application (e.g., tactics, segments, categories, or geographies) is severely limited in conventional behavioral analytics.

Currently, assets do not carry an attribute by which their individual, associative, and cumulative contributions to one or more communications initiatives can be characterized over a prescribed amount of time.

### BRIEF DESCRIPTION OF THE DRAWINGS

FIG. 1 is a flow chart of a content analytics process according to one embodiment of the present invention.

FIG. 2 is an example of an XML table according to one embodiment of the present invention.

FIG. 3A is a block diagram of a communications initiative according to one embodiment of the present invention.

FIG. 3B is a block diagram of a communication according to one embodiment of the present invention.

FIG. 4 is a block diagram of a content analytics system according to one embodiment of the present invention.

FIG. 5A is a graphical representation of an asset participating in a plurality of initiatives over time according to one embodiment of the present invention.

FIG. 5B is an example of a summary level data table according to one embodiment of the present invention.

FIG. 6A is a graphical representation of an asset participating in an initiative according to one embodiment of the present invention.

FIG. 6B is an example of an initiative level data table according to one embodiment of the present invention.

FIG. 7 is an example of an initiative performance normalization table according to one embodiment of the present invention.

### DETAILED DESCRIPTION

Embodiments of the present invention include a content analytics system and process. The content analytics system can include a server, an asset database, a network, an end user device, and a behavioral analytics data repository. The content analytics process can include, but is not limited to, attaching dynamic, event-based, behavioral analytics data associated with communications initiatives to an asset. Assets can include, but are not limited to, text, images, audio, video, media templates, copy, template layouts, design layouts, kits, bundles of documents, communication elements, and other forms of content present in a communications initiative.

In one embodiment, after an asset participates in a communications initiative, information relating to a performance of the communications initiative can be attached to metadata of the asset. For instance, after a communications initiative is determined to be successful or unsuccessful, information indicating the asset participated in a successful initiative or an unsuccessful initiative can be added to metadata of each asset participating in the communications initiative. Generally, metadata of an asset can be continuously updated with data and related analytics as the asset participates in communications initiatives.

By continuously updating asset metadata with behavioral analytics data, assets can be searched, filtered, selected, distributed, published and evaluated in unprecedented and highly useful and valuable ways. As such, statistical analysis of an asset can be enabled as behavioral analytics data and contextual data about an initiative the asset participated in is captured. Statistical analysis can include, but is not limited to, a determination of a capacity of the asset to contribute, positively or negatively, to an achievement of desired outcomes within a variety of contexts.

Embodiments of the present invention can be implemented with multi-channel one-way communications or interactive two-way communications each in a multi-channel context spanning traditional and digital media. For instance, communications channels can include, but are not limited to, email, websites, social pages, billboards, point of sale materials, print media, 2-dimensional barcode capture, sales data, 2-dimensional barcode scans, and coupon redemptions.

In one embodiment, the content analytics system can be implemented to optimize a large quantity of assets. For instance, a large organization may design, produce, and distribute over 100,000 assets in a given year. By implementing the content analytics system, the organization may determine that only a small subset of the assets systematically contribute to an effective performance. By determining which assets are successful, the quantity of assets designed and produced can be reduced.

Embodiments of the present invention can be implemented to determine if an asset (i) demonstrates a systematic pattern of contributing to disproportionately successful communications initiatives, (ii) demonstrates a systematic pattern of underperformance, and (iii) exhibits statistical differences in influencing outcomes when combined with other assets or contexts. For instance, a user may observe that communications initiatives including the asset exhibit better than average results. In another instance, a user may observe that the asset is tied to a disproportionate increase in results among a certain consumer market segment with regard to a certain product category and for certain geographies.

In one embodiment, a user can search for and select one or more assets for use in a communications initiative based on cumulative performance contributions of the one or more assets. For example, before a user begins preparing a communications initiative, the user can search for various assets that are relevant with regard to product category, geography, and/or target segment. The user may gain inspiration by reviewing assets that have proven successful in related product categories, geographies, and target segments.

In one embodiment, a relationship between an asset source and an accumulated performance of the asset can be analyzed. For instance, the asset source can be a design agency. A correlation between a performance contribution of an asset with the design agency can determine relevant trends or patterns. For example, an agency may design and/or produce assets with disproportionately high or low performance contributions. In another example, an agency may tend to produce assets that exhibit patterns of disproportionately high or low contribution under a variety of contextual factors. As such, insights regarding a relative performance of an asset over time and in different combinations or contexts can be discovered. Furthermore, asset effectiveness, productivity, or return on investment can be correlated with the agency which designed and/or produced the asset.

In one embodiment, a relationship between and among one or more assets can be analyzed by examining combinations of assets that have historically participated together in a common communications initiative. For example, a first image may be found to perform substantially well in association with a second image.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), an erasable programmable read-only memory (EPROM or Flash memory), an optical fiber, a portable compact disc read only memory (CD-ROM), and a digital video disk read only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, of otherwise professed in a suitable manner, if necessary, and then stored in a computer memory.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The terms “content analytics” or “asset analytics,” as used in this specification and the appended claims, refer to an assessment and characterization of an asset's demonstrated capacity to contribute to an effectiveness of a communications initiative under a variety of communications contexts with regard to an achievement of a variety of desired outcomes, whether for discrete initiatives, types of initiatives, or cumulative impact across all initiatives where the asset has participated over a span of time.

### An Embodiment of a Content Analytics Process

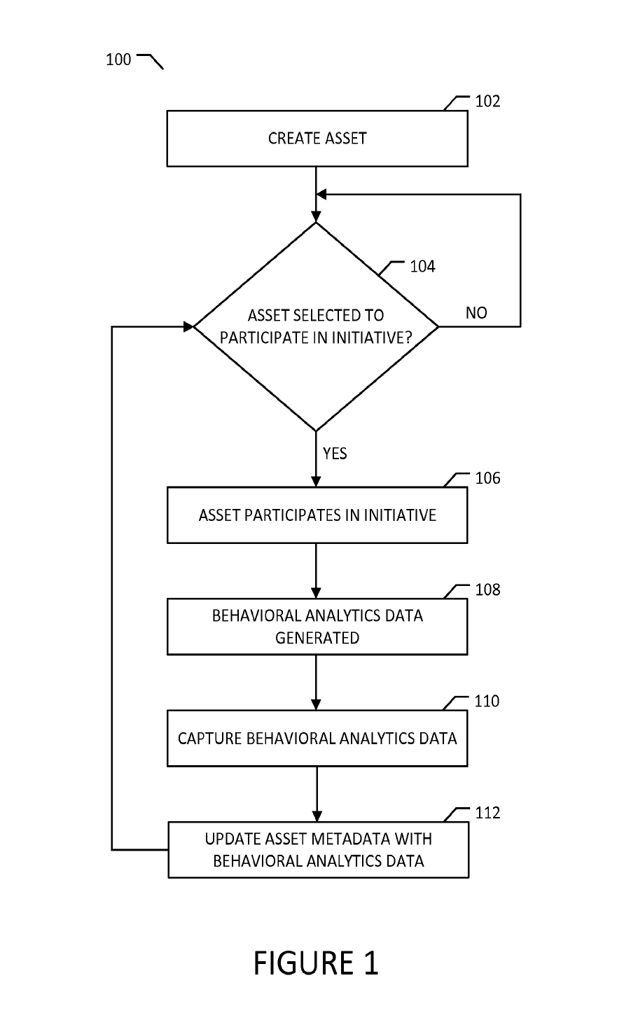

Referring to FIG. 1, a flow chart of a method or process 100 is illustrated. The process 100 can be implemented to continuously attach behavioral analytics data to an asset throughout a life of the asset.

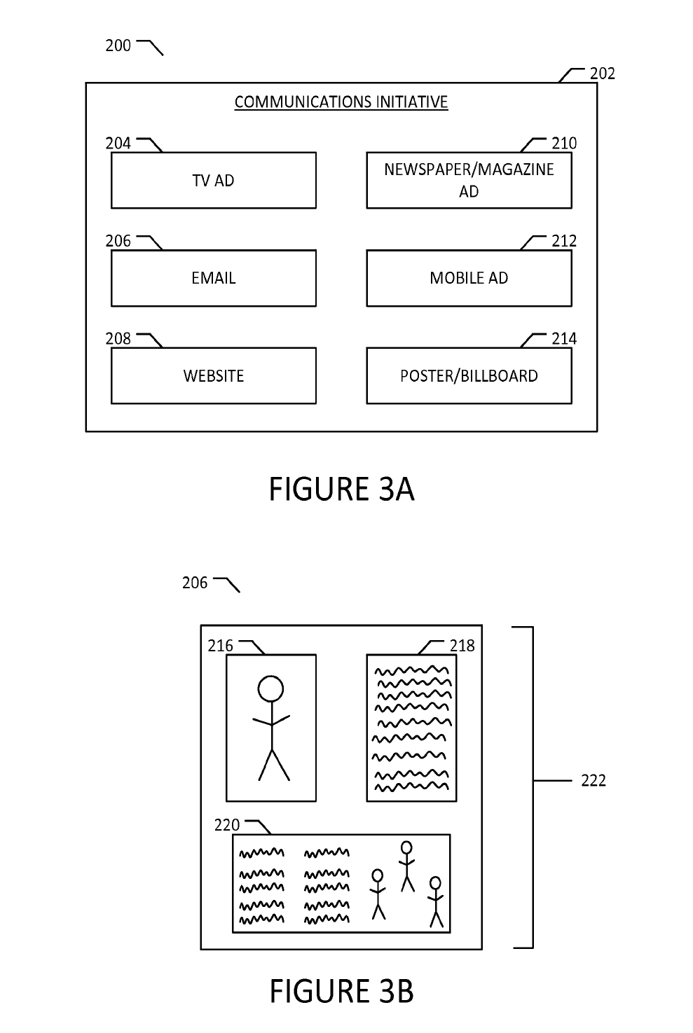

In block 102, an asset can be created. An asset can include, but is not limited to, text, images, audio, video, media templates, copy, template layouts, design layouts, kits, bundles of documents, communication elements, and other forms of content present in a communications initiative. For instance, an asset can be an image of a school bus. In another instance, an asset can be a template used to create a webpage. An example communication having a plurality of assets is illustrated in FIG. 3B.

When creating an asset, asset metadata can be adapted to include fields related to behavioral analytics data. An exemplary metadata table is described in more detail hereinafter. Generally, behavioral analytics data can include performance data and related contextual factors. Performance data can include outcomes and conversions associated with particular initiatives. Contextual factors can include, but are not limited to, target demographics, geographies, reach, media channels, etc. In one embodiment, behavioral analytics data can include, but is not limited to, a number of times an asset is used, a number of times an asset is selected to be in a communication, and a personal opinion of an asset by a user who selected the asset for use in a communication.

Generally, after the asset is created, the asset can be implemented in a communications initiative. In block 104, the process 100 can determine if the asset was selected to participate in an initiative. If the asset is not selected, the process 100 can return to block 104. If the asset is selected for participation in an initiative, the process 100 can move to block 106.

The asset can participate in an initiative in block 106. An initiative can refer to a marketing campaign, advertising campaign, public service announcement, etc. Generally, the initiative can include one or more communications. Communications can include posters, emails, websites, mobile advertisements, etc. The communications can include one or more assets. For instance, the school bus could be implemented in a school related communications initiative. In one example, the communications initiative could target children aimed to sell books to those children. The school bus could be used in a poster to sell books to children. It is to be appreciated that a communications initiative can be delivered by a plurality of well known means. For instance, digital communications can be delivered via a smart phone, laptop, and tablet. In another instance, print communications can be delivered by magazines, newspapers, and posters.

As the asset participates in the initiative, behavioral and analytical data related to the communications initiative can be generated in block 108. Behavioral analytics data can include, but is not limited to, cumulative statistics, aggregated statistics, and contextual data. Typically, the cumulative and aggregated statistics relate to a performance of the communications initiative. In some embodiments, the cumulative and aggregated statistics can be updated periodically throughout a life of the communications initiative. Contextual data can include, but is not limited to, target reach, average reach, target regions, target customer segments, and categories of product.

In some embodiments, the behavioral analytics data can be generated from third party vendors who provide behavioral analytics data. Typically, raw data related to the initiative can be analyzed to generate a plurality of behavioral analytics data. It is well known in the art that behavioral analytics data is available from a variety of different sources. It is to be appreciated that the behavioral analytics data can be generated by a variety of well known means.

Behavioral analytics data can be captured in block 110. For instance, only behavioral analytics data related to the initiative the asset participated in can be captured. If the asset participated in multiple initiatives, behavioral analytics data related to each initiative can be captured. Generally, the behavioral analytics data can be captured from a company who analyzes raw data and generates the behavioral analytics data. In some embodiments, behavioral analytics data can be captured from raw data related to an initiative.

In block 112, metadata of the asset can be updated with the captured behavioral analytics data. Generally, the asset can be updated after the initiative ends. In some embodiments, the asset can be updated on a daily, weekly, bi-weekly, monthly, or yearly basis. It is to be appreciated that the asset metadata can be updated in a variety of timed intervals depending on an implementation.

After the asset metadata is updated, the process 100 can return to block 104 to determine if the asset was selected to participate in another initiative. Generally, the process 100 can be implemented for a life of an asset. In one embodiment, the process 100 can be implemented for a set period of time, as defined by a user. For example, the process 100 can be implemented for a three year period for an asset.

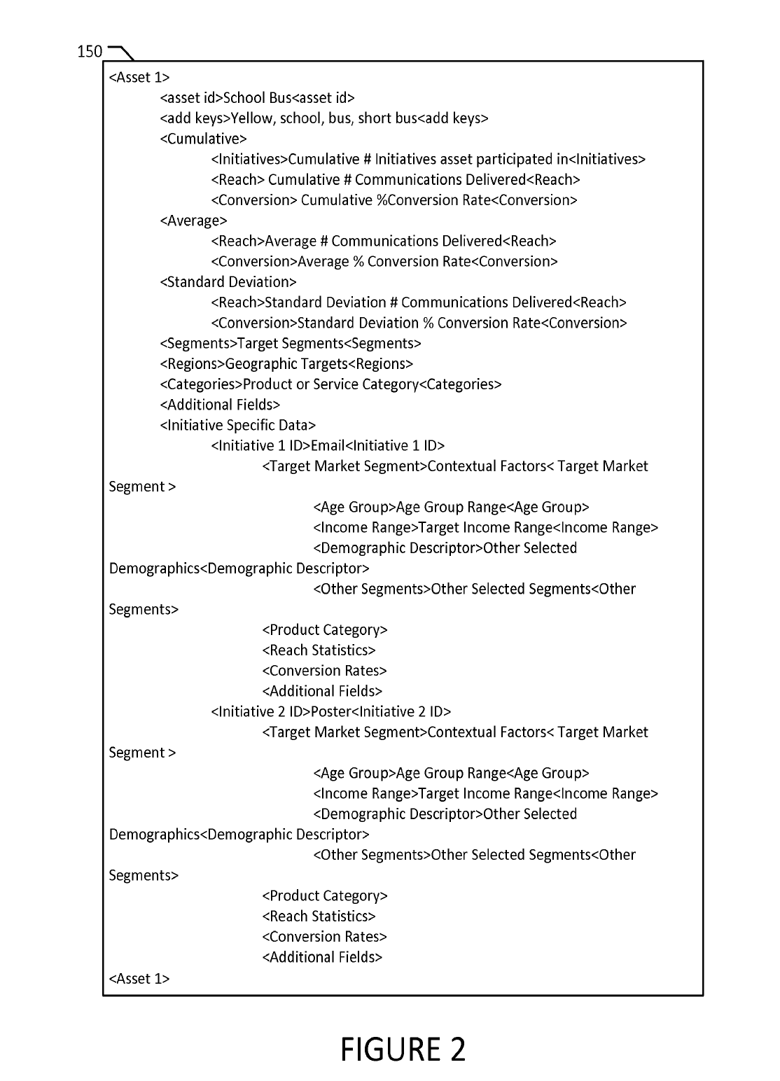

Referring to FIG. 2, an example asset metadata 150 in an XML format is shown. FIG. 2 is for illustrative purposes only and includes generic terms not meant to be limiting.

Metadata has conventionally been implemented to describe an asset and serve to facilitate characterization of properties of the asset. Metadata can be useful in cataloging or organizing assets in libraries, repositories, or asset management systems. For instance, conventional metadata can identify an asset as an image having a media format and file density. The metadata can further characterize what the image is of For example, the metadata can include information indicating that the image is of a person, whether the person is male or female, and what ethnicity the person in the image is.

It is to be appreciated that descriptive information associated with conventional approaches to asset metadata can be useful for purposes of searching, filtering, categorizing, organizing, finding and retrieving assets which may be suitable for particular communications initiatives. However, conventional metadata fails to characterize assets in terms of contribution to performance in achieving desired outcomes in various communications initiatives.

As shown, the metadata 150 can include information relating to an Asset 1. Information in the metadata 150 relating to Asset 1 can include, but is not limited to, an asset identifier, additional keys, cumulative statistics, average statistics, standard deviation statistics, segments, regions, categories, and additional fields. Further information can relate to initiatives the asset has participated in. For instance, Initiative ID 1 can include behavioral analytics data relating to that communications initiative. Initiative ID 2 can include behavioral analytics data relating to that communications initiative. It is to be appreciated that the metadata 150 is for illustrative purposes only and included as one example of metadata captured in the present invention.

In one embodiment, asset metadata can include unstructured metadata attributes that characterize associations between an asset and related communications initiatives and associated contextual information. For instance, free text can be added to asset metadata. Generally, free text can include a variety of information found pertinent to analyzing the asset that does not fit into the structured metadata fields.

In one embodiment, the process 100 can include a step of rationalizing, abstracting, or summarizing data to determine how much data is attached to metadata of an asset. For instance, statistical summarization and/or archiving can be implemented to reduce a size of the asset.

Referring to FIGS. 3A-3B, an example communications initiative 200 and an example communication 206 are illustrated. The communications initiative 200 illustrated in FIG. 3A is an example of a communications initiative having a plurality of communications that each includes one or more assets.

The communications initiative 200 can include a plurality of communications 204-216. In one embodiment, the first communication 204 can be a television advertisement, the second communication 206 can be an email campaign, the third communication 208 can be a website, the fourth communication 210 can be a newspaper/magazine advertisement, the fifth communication 212 can be a mobile advertisement, and the sixth communication 214 can be a poster/billboard advertisement. It is to be appreciated that the communications initiative 200 can include more or less communications and a variety of different communication types.

As shown in FIG. 3B, the email communication 206 can include a plurality of assets 216-220. In one embodiment, the first asset 216 can be an image, the second asset 218 can be text, and the third asset 220 can be a combination text and image. In some embodiments, the email communication 206 can include a template asset 222 allowing a user to pick which assets are associated with the assets 216-220. For instance, one user can pick three images to be the first asset 216, the second asset 218, and the third asset 220.

### An Embodiment of a Content Analytics System

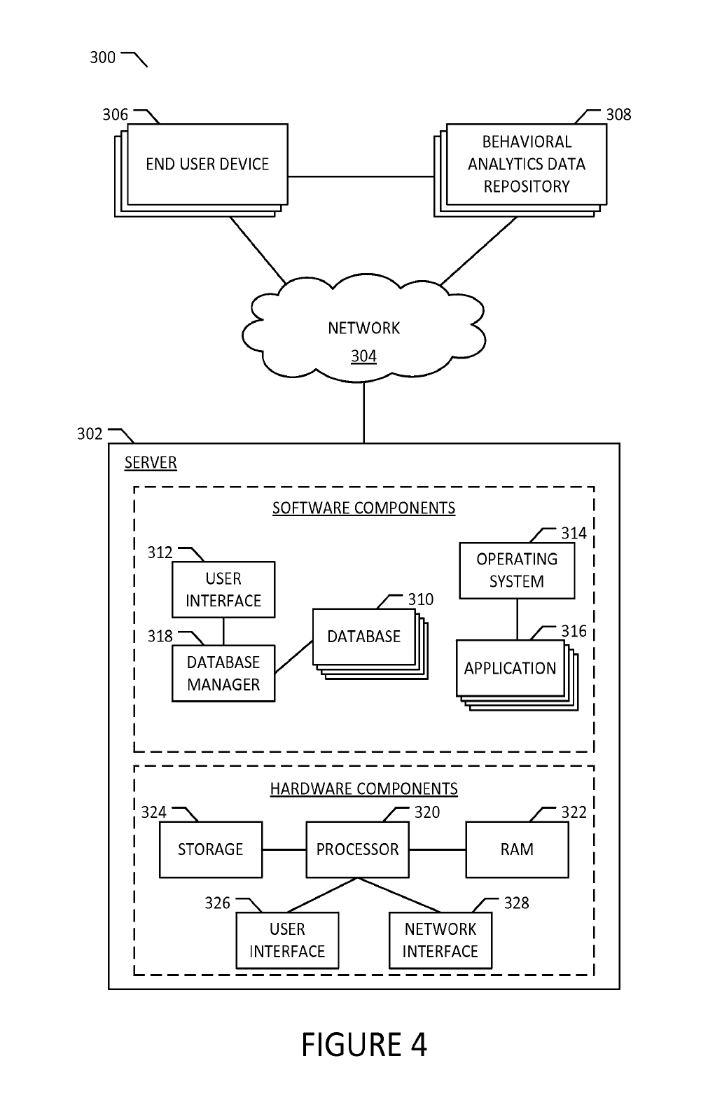

Referring to FIG. 4, a detailed diagram of an embodiment 300 showing a content analytics system is illustrated. The content analytics system 300 can be implemented to create an asset database including assets having behavioral analytics data associated with each asset.

Generally, the content analytics system 300 can include a server 302, a network 304, one or more end user devices 306, and one or more behavioral analytics data repositories 308.

Generally, a repository of assets can be stored in the server 302. In one embodiment, the repository of assets can be stored in the one or more databases 310. It is to be appreciated that the repository of assets can be stored externally to the server 302. For instance, the databases 310 can be remotely located from the server 302. Typically, a user can access the database 310 and search, query, filter, and/or prioritize the repository of assets. For instance, the database 310 can be accessed through a web interface. In another instance, the user can have direct access to the database 310. For example, the server 302 can include a user interface or web based interface 312 to access the database 310.

The server 302 can represent a server or another powerful, dedicated computer system that can support multiple user sessions. In some embodiments, the server 302 can be any type of computing device including, but not limited to, a personal computer, a game console, a smartphone, a tablet, a netbook computer, or other computing devices. In one embodiment, the server 302 can be a distributed system wherein server functions are distributed over several computers connected to a network. The server 302 can have a hardware platform and software components.

The software components of the server 302 can include the one or more databases 310 which can store a plurality of assets. The software components can also include an operating system 314 on which various applications 316 can execute. A database manager 318 can be an application that runs queries against the databases 310. In one embodiment, the database manager 318 can allow interaction with the databases 310 through an HTML user interface on an end user device 306.

In one embodiment, the server 302 can include a program or application to create an asset. The asset generation program can include a plurality of behavioral analytics data fields in the asset metadata. The server 302 can include a program to capture behavioral analytics data from at least one of the behavioral analytics data repositories 308. In some embodiments, the asset generation program can be the same program as the behavioral analytics data capturing program. It is to be appreciated that the two programs can be independent programs.

The hardware platform of the server 302 can include, but is not limited to, a processor 320, random access memory 322, and nonvolatile storage 324. The processor 320 can be a single microprocessor, multi-core processor, or a group of processors. The random access memory 322 can store executable code as well as data that can be immediately accessible to the processor. The nonvolatile storage 324 can store executable code and data in a persistent state.

The hardware platform can include a user interface 326. The user interface 326 can include keyboards, monitors, pointing devices, and other user interface components. The hardware platform can also include a network interface 328. The network interface 328 can include, but is not limited to, hardwired and wireless interfaces through which the server 302 can communicate with other devices including, but not limited to, the end user devices 306 and the behavioral analytics data repositories 308.

The network 304 can be any type of network, such as a local area network, wide area network, or the Internet. In some cases, the network 304 can include wired or wireless connections and may transmit and receive information using various protocols.

The one or more end user devices 306 can be any type of computing device on which a browser can operate. Examples of such devices can include, but are not limited to, desktop computers, laptop computers, tablet computers, mobile telephones, game consoles, network appliances, or any other web-enabled devices. In an embodiment, the end user devices 306 can have various hardware platforms on which a browser can execute. The browser can be used to access the HTML user interface of the database manager 318.

In one embodiment, the behavioral analytics data repository 308 can be a database where behavioral analytics data is consolidated and stored. For instance, after a communications initiative ends and behavioral analytics data related to the communications initiative is generated, the behavioral analytics data can be sent to the behavioral analytics data repository 308.

In one example, an asset can be created and stored by one of the databases 310 of the server 302. The asset can be selected to participate in a communications initiative by one of the end user devices 306. For instance, an initiative designer can select the created asset to participate in an initiative. While the asset participates in the initiative, raw data related to the initiative can be analyzed to generate behavioral analytics data. As the behavioral analytics data is generated, the behavioral analytics data can be stored in one of the behavioral analytics repositories 308. The behavioral analytics data stored in the behavioral analytics repositories 308 can be sent to the server 302. An application running on the server 302 can update the asset metadata with the received behavioral analytics data. In some embodiments, the application can update the asset metadata as new behavioral analytics data is generated. In one embodiment, the asset metadata can be updated after the initiative ends.

The content analytics system 300 can include a query program. In one embodiment, the query program can be implemented as an application. Generally, the application can be embodied on a variety of computing devices. For instance, the query program can be embodied on a smart phone, laptop, desktop, and tablet. The query program can provide access to the asset database 310.

In one example, a marketing campaign designer can implement the query program to access the asset database 310 via the end user device 306 having a web browser. While formulating a new communications initiative, the marketing campaign designer can search, filter, prioritize, and select assets based on historical performance of the assets with regard to intended market segments, geographic regions, and/or product categories. Since the historical impact of an initiative is associated with or attached to an asset, the assets can be searched without prior knowledge of initiatives the assets participated in. The marketing campaign designer can search for assets that have demonstrated a disproportionately positive contribution in the achievement of empirical market outcomes. The marketing campaign designer can then filter the assets based on those assets that have contributed disproportionately to desired outcomes with specific regard to the target market segments, geographies, and/or product categories most relevant to the objectives of the user.

In one embodiment, the query program can be adapted to allow a user to have the ability to analyze (i) an asset by itself, apart from communications initiatives the asset participated in and (ii) an asset in combination with other assets participating in the same or similar communications initiatives.

In one embodiment, designers of creative materials including creative assets can seek, prioritize, filter, or otherwise organize assets based on information regarding the cumulative participation in and/or contribution to communication initiatives by such an asset using the query program. For instance, a user can organize the asset database 310 based on (i) cumulative participation in communications initiatives by an asset and (ii) cumulative contribution to communications initiatives by an asset.

The query program can be adapted to allow for analysis of asset participation in and/or contribution to communications initiatives together with information regarding the source of asset design and/or production, and other contextual factors regarding the lifecycle of assets and their use in isolation or in combination with other assets. The query program can include the ability to filter the asset database 310 based on the source of the asset and other contextual factors.

In some embodiments, the asset database 310 can be consolidated by selecting contextual data attributes characterizing the communications initiatives within which an asset participated or contributed. For instance, an asset may participate in or contribute to an arbitrary number of communications initiatives over arbitrary periods of time. Such initiatives may vary widely in terms of communications media, geographies, customer segments, product categories, seasons, days, times, desired outcomes, and a host of other contextual factors. The query program can effectively, and efficiently, collect and consolidate relevant contextual data characterizing initiatives within which the asset participated in. Furthermore, selected contextual data can be added to metadata of the asset. More specifically, relevant contextual data can be added to assets that characterize communications the assets participated in.

Typically, communications initiatives are executed across a wide array of communications channels via a variety of communications technologies and devices, with differing data capture mechanisms and formats for the acquisition of behavioral analytics data. Any given asset can be used across a variety of communications initiatives and related media systems, each of which can have different behavioral analytic outcomes, data attributes, data definitions, and data capture methods and formats.

In one embodiment, the content analytics system 300 can include a program adapted to select relevant behavioral analytics data. For instance, the program can be automated to select a predetermined set of data points. In another instance, the program can allow a user to select which behavioral analytics data points to capture.

Generally, the content analytics system 300 can include a program adapted to identify and consolidate selected data and translate non-conforming data into a common syntax for purposes of the asset database 310. In one embodiment, the translation program can be adapted to translate a broad array of data types into a common syntax for each asset. The program can translate or trans-create diverse and inconsistent behavioral analytics data to be consolidated into a common asset analytics framework. As such, diverse communications initiatives can contribute relevant performance data characterizing an asset with a universal asset data model. For instance, a universal asset data model can be implemented to allow multiple diverse communication initiatives to contribute relevant performance data characterizing each asset.

Typically, the translation of behavioral and contextual data into a standardized framework for the asset repository requires pragmatic mapping of data points from one domain into another. In doing so, there are frequently “mismatches” or lack of perfect one-to-one correspondence between two data domains. For example, a communications initiative may target a certain target market segment of men and women between the ages of 30 and 45. However, a data domain associated with the asset may accumulate data in different ranges including men and women ages 25 to 35.

The translation program can be adapted to reconcile disparities between initiative behavioral analytics data and defined data inputs for an asset. In one embodiment, the translation program can be adapted to re-map or translate from a first data domain to a second data domain. For instance, the translation can be based on an alignment of maximum common data subsets and related performance data. If available, performance data of an initiative can be isolated in more granular data subsets so as to better align relevant units of analysis between behavioral and asset analytics data pools. Using the above example, analytics data can be isolated within a communications initiative corresponding only to men and women between the ages of 30 to 35. Generally, when combining different data domains, areas where two differing data sets overlap can be found and used as part of the behavioral analytics data attached to the asset.

In one embodiment, the translation program can include a weighting factor. The weighting factor can be implemented to consolidate and reconcile two different data domains. In one instance, the weighting factor can be based on the degree of alignment between the two data domains. The weighting factor can be implemented when precision is not essential and indicative contributions are adequate. For instance, in the example above, the misalignment between the two age ranges may not be considered material. In order to address the misalignment, the weighting of communications initiatives relative to other communications initiatives that an asset has participated in can be discounted by an appropriate amount that reflects an impact of the misalignment between the two data domains.

In one embodiment, an index can be created to normalize a relative impact of an asset to contribute to a success of various communications initiatives the asset has participated in. In one instance, the index can be discounted when there is an imperfect match between behavioral and asset data domains with regard to a communications initiative, as exemplified above. For example, an asset can participate in two communications initiatives. The first results in a 10% point-of-sale conversion where 10% of individuals seeing the communication respond by completing a purchase. The second results in a 4% conversion rate. Considering all other factors being equal, one might conclude that the asset participated in initiatives with a cumulative average of 7% conversion rate. However, if the first communications initiative was delivered to one million recipients and the second was delivered to one hundred thousand recipients, then it may not be desirable that the results would have equal weighting in defining a contribution of the asset to accumulated results over time and across initiatives.

In one embodiment, the content analytics system 300 can include a program adapted to create an index to normalize a relative impact of an asset over a prescribed time and plurality of initiatives. For instance, the normalization can include weighting contextual factors based on a number of people seeing each of the communications initiatives. In another instance, the normalization can include weighting contextual factors based on how many different communications initiatives the asset participated in. For example, as an asset is used for longer periods of time, the asset may begin to have a lower impact on a communications initiative. As such, the relative contribution of an asset can be weighted based on the number of communications initiatives the asset has participated in. For instance, the first communications initiative an asset participates in can be weighted heavier than the fifth communications initiative the asset participated in.

The content analytics system 300 can include a plurality of means to adjust a relevance of communications initiatives in characterizing a cumulative contribution of an asset. Means can include, but are not limited to, allowing for a specification of an adjustment factor or index value based on data domain alignment. For instance, a 100% or “1” can be for a substantially perfect domain alignment, a 50% can be for approximately a mid-range alignment, etc. In one embodiment, the index value can be further factored by a total volume of corresponding communications initiatives. For example, a weighting based on per-mille communications delivered or million individuals reached can be implemented.

In one embodiment, the content analytics system 300 can include a program adapted to map behavioral analytics data to asset data by establishing a performance index to normalize performance contributions of an asset across a disparate set of outcomes and different contexts, media, etc. For example, a conversion rate for a number of emails opened in response to a communication might yield a long-term average of 4% where on average, across a range of email initiatives, 4% of email recipients open the email. A first initiative may yield a conversion rate of 6.5% where 6.5% of recipients opened the email.

In one example, a normalizing performance index (PI) can be derived as a difference between a conversion rate of an initiative (PC) and a population conversion rate average (PA), divided by the population conversion rate average.

PI=[PC−PA ]/PA

The population conversation rate average can include, but is not limited to, an average across a population of results that can include long term averages across successive initiatives and an average across a set of initiatives which share common characteristics with an initiative of interest.

### Examples of Content Analytics Asset Metadata Tables

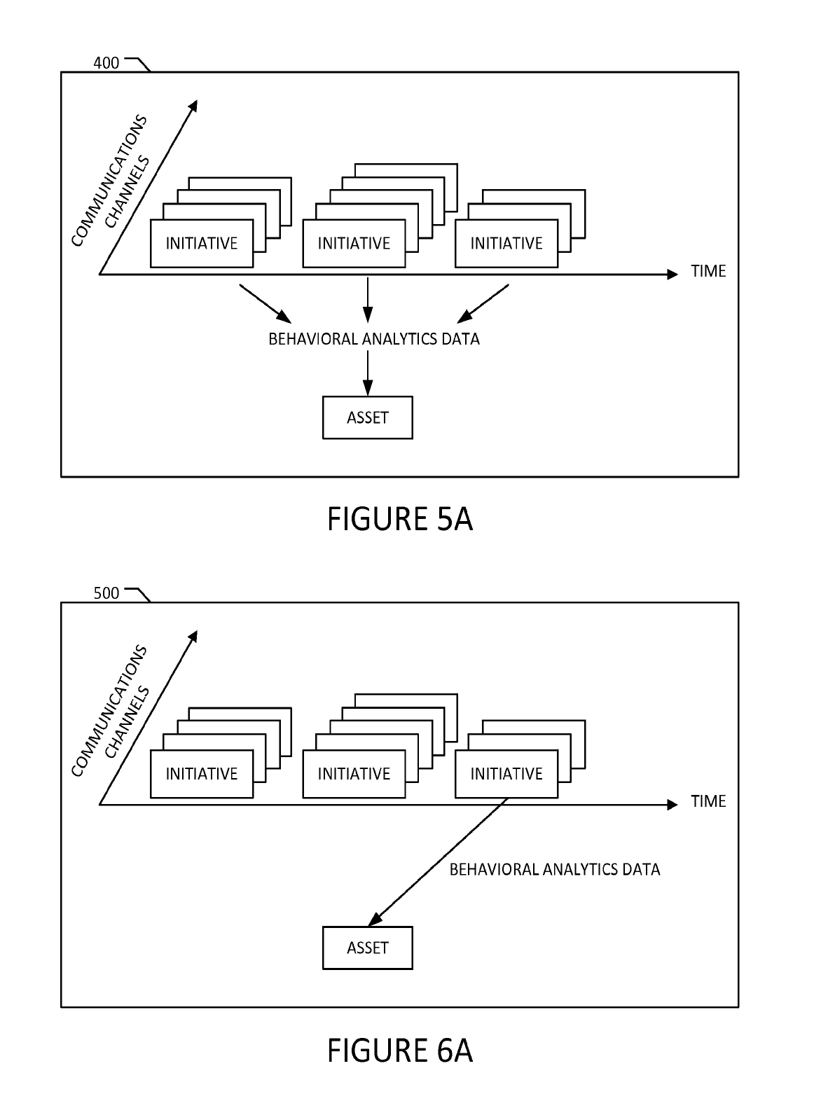

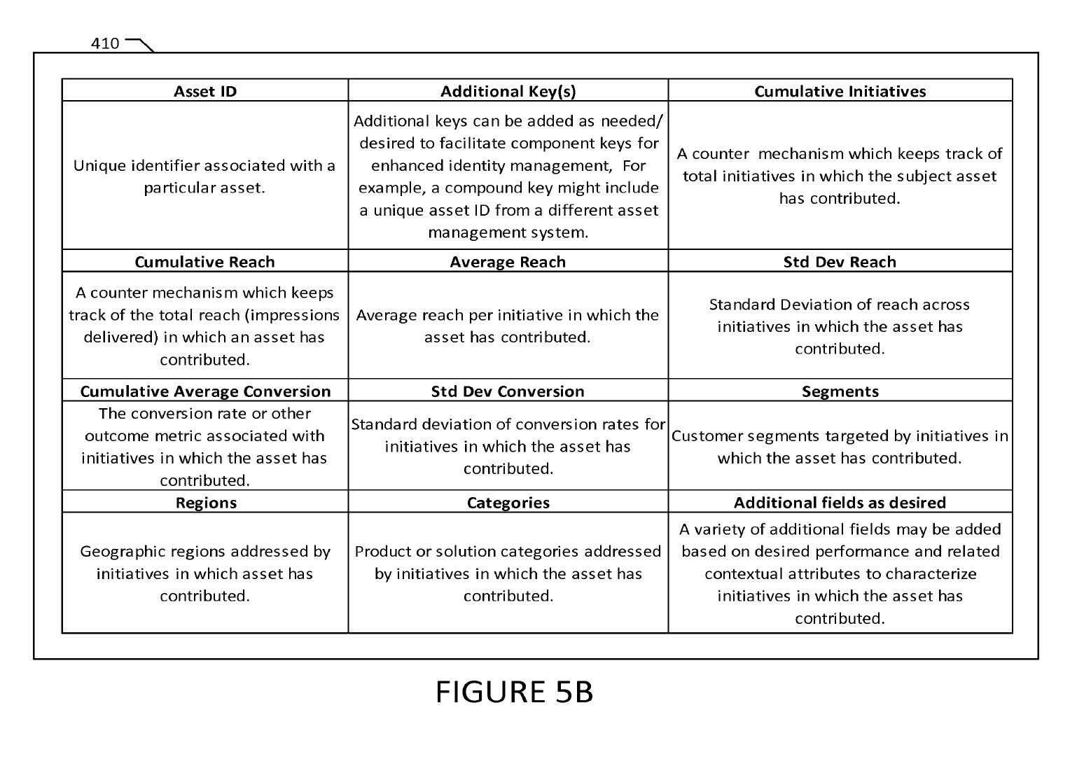

Referring to FIG. 5A, a diagram of a chart 400 illustrating an asset participating in a plurality of initiatives over an infinite amount of time is shown. Behavioral analytics data related to each of the plurality of initiatives is also shown being attached to the asset over time.

FIG. 5B is a diagram of a data table 410 showing a plurality of behavioral analytics data points included in metadata of the asset from FIG. 5A. Generally, the data table 410 can be a summary level data table including data points for each of the initiatives the asset participates in.

Generally, summary level data can include (i) cumulative and aggregated statistics reflecting performance and (ii) contextual factors associated with initiatives within which assets contribute over their active lives and across media channels.

Data fields including, but not limited to, asset identification, additional key(s), cumulative initiatives, cumulative reach, average reach, standard deviation reach, cumulative average conversion, standard deviation conversion, segments, regions, categories, and additional fields as desired can be included in the summary level data table 410. It is to be appreciated that the listed data fields are not meant to be limiting but are examples of data fields that can be included in asset metadata.

The asset identification data field can include a unique identifier associated with a particular asset. The additional key(s) field can include additional keys as needed to facilitate component keys for enhanced identity management. For example, a compound key might include a unique asset ID from a different asset management system. The cumulative initiatives filed can include a counter mechanism which keeps track of total initiatives in which an asset has contributed. The cumulative reach data field can include a counter mechanism which keeps track of the total reach (e.g., impressions delivered) in which an asset has contributed. The average reach data field can include an average reach per initiative in which the asset has contributed. The standard deviation reach data field can include a standard deviation of reach across initiatives in which the asset has contributed. The cumulative average conversion data field can include a conversion rate or other outcome metric associated with initiatives in which the asset has contributed. The standard deviation conversion data field can include a standard deviation of conversion rates for initiatives in which the asset has contributed. The segments data field can include customer segments targeted by initiatives in which the asset has contributed. The regions data field can include geographic regions addressed by initiatives in which asset has contributed. The categories data field can include product or solution categories addressed by initiatives in which the asset has contributed. The additional fields as desired data field can include a variety of additional fields that may be added based on desired performance and related contextual attributes to characterize initiatives in which the asset has contributed.

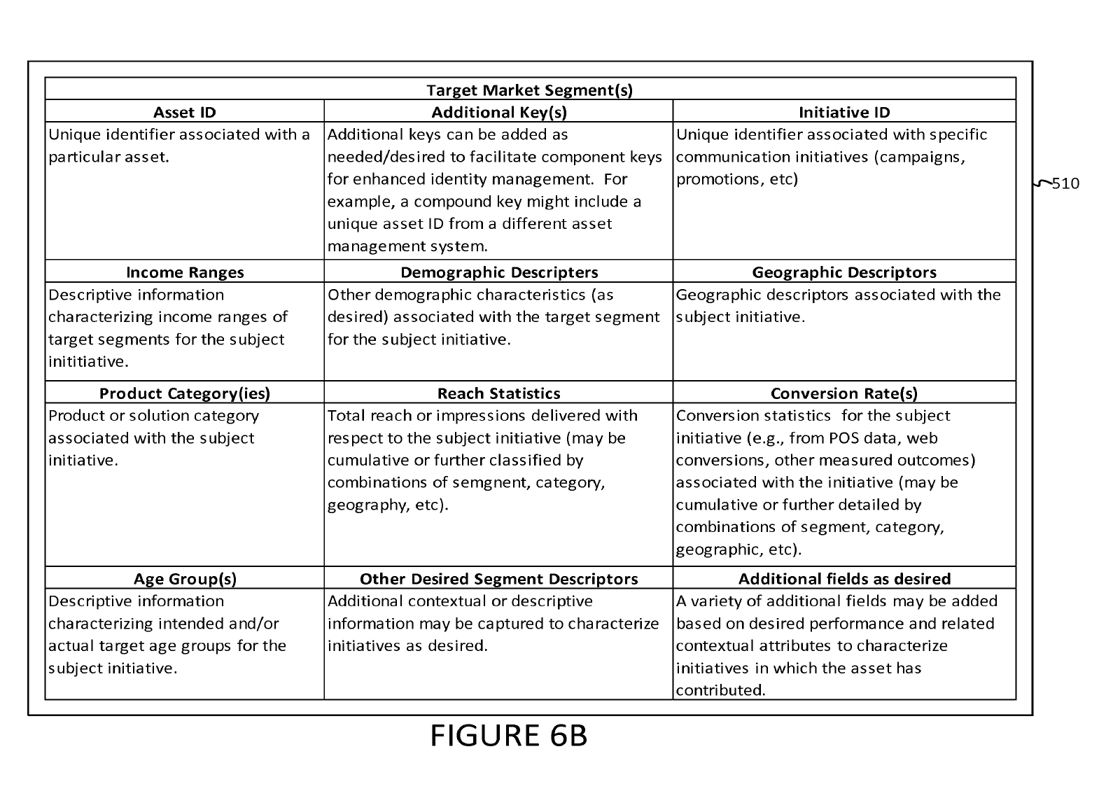

Referring to FIG. 6A, a diagram of a chart 500 illustrating an asset participating in an initiative is shown. Behavioral analytics data related to the initiative is also shown being attached to the asset.

FIG. 6B is a diagram of a data table 510 showing a plurality of behavioral analytics data points included in metadata of the asset from FIG. 6A. Generally, the data table 510 can be an initiative level data table including data points related to the initiative the asset is participating in.

Data fields including, but not limited to, asset identification, additional key(s), initiative identification, product category, reach statistics, conversion rate(s), and additional fields as desired can be included in the initiative level data table 510. In one embodiment, the initiative level data table 510 can include target market segments data fields. The target market segment data fields can include, but are not limited to, age group(s), income ranges, demographic descriptors, geographic descriptors, and other desired segment descriptors. It is to be appreciated that the listed data fields are not meant to be limiting but are examples of data fields that can be included in asset metadata.

The asset identification data field can include a unique identifier associated with a particular asset. The additional key(s) field can include additional keys as needed to facilitate component keys for enhanced identity management. The initiative identification data field can include a unique identifier associated with specific communication initiatives, campaigns, promotions, etc. The product category data field can include information related to a product or solution category associated with an initiative. The reach statistics data field can include total reach or impressions delivered with respect to a particular initiative. Generally, the reach statistics data field can be cumulative or further classified by combinations of segment, category, geography, etc. The conversion rate(s) data field can include conversion statistics for a particular initiative. For example, point of sale statistics, web conversions, and other measured outcomes can be included. The conversion statistics can be cumulative or further detailed by combinations of segment, category, geographic, etc. The additional fields as desired data field can include a variety of additional fields that can be added based on desired performance and related contextual attributes to characterize initiatives in which the asset has contributed.

The age group(s) data field can include descriptive information characterizing intended and/or actual target age groups for a particular initiative. The income ranges data field can include descriptive information characterizing income ranges of target segments for a particular initiative. The demographic descriptors data field can include other demographic characteristics associated with a target segment for a particular initiative. The geographic descriptors data field can include geographic descriptors associated with a particular initiative. The other desired segment descriptors data field can include additional contextual or descriptive information that can be captured to characterize initiatives as desired.

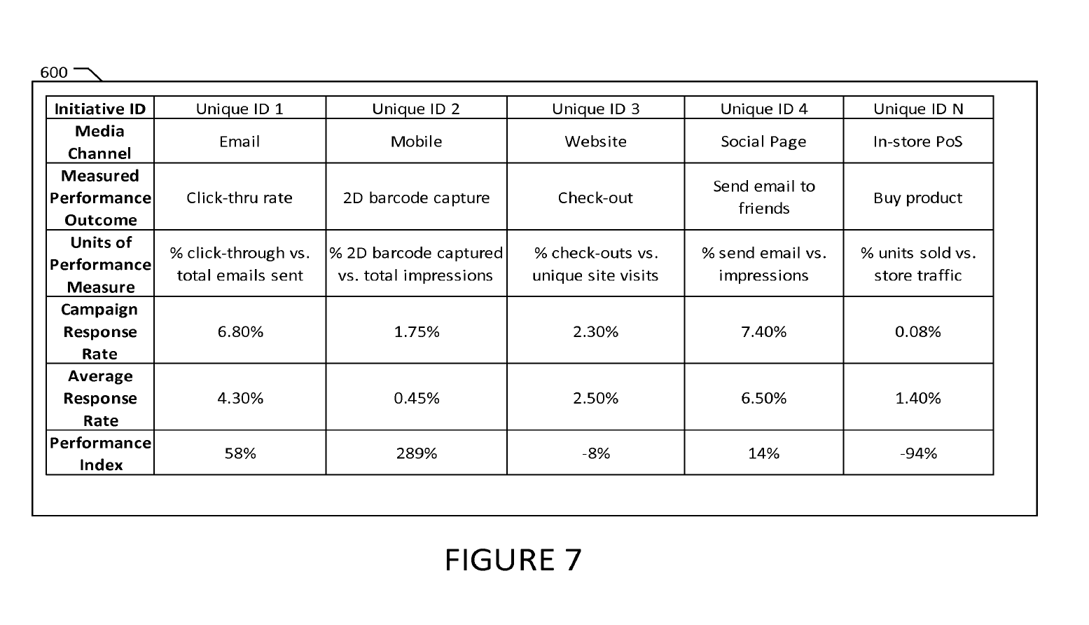

Referring to FIG. 7, a diagram of a data table 600 illustrating a normalization of performance for an asset participating in a plurality of initiatives is shown.

The normalization table 600 can include one or more data fields including, but not limited to, “Campaign ID”; “Media Channel”; “Measured Performance Outcome”; “Units of Performance Measure”; “Campaign Response Rate”; “Average Response Rate”; and “Performance Index.”

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A method performed on a processor, the method comprising:
creating an asset having metadata;
determining the asset participated in a first initiative;
capturing behavioral analytics data related to the first initiative; and
updating the asset metadata with the behavioral analytics data related to the first initiative.

2. The method of claim 1, further comprising the steps of:
determining the asset participated in a second initiative;
capturing behavioral analytics data related to the second initiative; and
updating the asset metadata with the behavioral analytics data related to the second initiative.

3. The method of claim 1, wherein the behavioral analytics data includes performance data.

4. The method of claim 3, wherein the behavioral analytics data includes contextual data.

5. The method of claim 1, wherein the asset metadata is updated for a life of the asset.

6. The method of claim 1, further comprising the step of:
storing the updated asset metadata in a database.

7. The method of claim 1, wherein the asset is selected from a group consisting of an image, a video, audio, media templates, copy, template layouts, design layouts, kits, and bundles of documents.

8. The method of claim 1, wherein the first initiative is selected from a group consisting of a television advertisement, an email campaign, a website, a newspaper advertisement, a magazine advertisement, a mobile advertisement, a poster, and a billboard.

9. The method of claim 8, wherein the second initiative is selected from a group consisting of a television advertisement, an email campaign, a website, a newspaper advertisement, a magazine advertisement, a mobile advertisement, a poster, and a billboard.

10. A content analytics system comprising:
at least one processor;
at least one computer-readable storage media having stored thereon computer-executable instructions that, when executed by the at least one processor, causes the system to perform a method, the method comprising the following:
creating an asset having metadata;
determining the asset participated in a first initiative;
capturing behavioral analytics data related to the first initiative; and
updating the asset metadata with the behavioral analytics data related to the first initiative.

11. The content analytics system of claim 10, the method further comprising the steps of:
determining the asset participated in a second initiative;
capturing behavioral analytics data related to the second initiative; and
updating the asset metadata with the behavioral analytics data related to the second initiative.

12. The content analytics system of claim 10, wherein the behavioral analytics data includes performance data.

13. The content analytics system of claim 12, wherein the behavioral analytics data includes contextual data.

14. The content analytics system of claim 10, wherein the asset metadata is updated for a life of the asset.

15. The content analytics system of claim 10, wherein the asset is selected from a group consisting of an image, a video, audio, media templates, copy, template layouts, design layouts, kits, and bundles of documents.

16. The content analytics system of claim 10, wherein the first initiative is selected from a group consisting of a television advertisement, an email campaign, a website, a newspaper advertisement, a magazine advertisement, a mobile advertisement, a poster, and a billboard.

17. The content analytics system of claim 16, wherein the second initiative is selected from a group consisting of a television advertisement, an email campaign, a website, a newspaper advertisement, a magazine advertisement, a mobile advertisement, a poster, and a billboard.

18. The content analytics system of claim 10, the system further comprising:
at least one database adapted to store a plurality of assets.

19. The content analytics system of claim 10, wherein the behavioral analytics data is captured from a plurality of repositories.

20. A method performed on a computer processor, said method comprising:
creating an asset having metadata;
determining the asset participated in a first initiative;
capturing behavioral analytics data related to the first initiative;
updating the asset metadata with the behavioral analytics data related to the first initiative.
determining the asset participated in a second initiative;
capturing behavioral analytics data related to the second initiative; and
updating the asset metadata with the behavioral analytics data related to the second initiative;
wherein the behavioral analytics data includes performance data and contextual data.
